(19) United States
(12) Patent Application Publication
(10) Pub. No.: US 2024/0149172 A1
(43) Pub. Date: May 9, 2024

(54) SERVERLESS NETWORKING PROTOCOL FOR MULTIPLAYER GAMES

(71) Applicant: DISCORD INC., San Francisco, CA (US)

(72) Inventors: Bojan Jovanovic, Miami, FL (US); Ankit Kumar, New York City, NY (US); Sahn Lam, San Francisco, CA (US); Andrés Rivela, Vancouver (CA)

(21) Appl. No.: 18/052,949

(22) Filed: Nov. 7, 2022

(51) Int. Cl. A63F 13/77; A63F 13/35; G06F 8/65; H04L 67/131

(52) U.S. Cl. CPC A63F 13/77; A63F 13/35; G06F 8/65; H04L 67/131; A63F 2300/552

(57) ABSTRACT

The present technology provides a low latency stateful serverless networking protocol to support persistent multiplayer state synchronization. The fundamental system is a key-value data store that uses transactions to ensure state coherency synchronized across many clients. Each client subscribes to state updates as well as orchestrates state writes by attempting to lock and write the next available key and then assumes that its state update will succeed to reduce perceived latency. If the key was incorrectly assumed to be submitted in the right order, the client rolls back its assumption and tries the process again.

### BACKGROUND

Some social networks are developed around friendships, professional relationships, or other individual connections, and some social networks create communities around topics. Often social networking platforms provide services through which users can form or interact within a social network. Users can generally post comments or other content, make connections, add links, or simply browse content created by others. Some social networks have moderators that moderate the content in their respective social networks or online communities. While social networks can provide entertainment, networking, commercial, or informational value, they are also subject to various challenges. Providing various multi-player gaming options for users in the social networks may face many scaling and latency issues.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof, which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates an example system that is configured to support user accounts in creating, managing, and participating in online communities in accordance with some aspects of the present technology.

FIG. 2A illustrates an example of a user interface presented by a client application in accordance with some aspects of the present technology.

FIG. 2B illustrates an example of a user interface presented by a client application in accordance with some aspects of the present technology.

FIG. 3 illustrates an example flow diagram for a low latency stateful serverless networking architecture for facilitating online games, according to some examples of the present disclosure.

FIG. 4 illustrates an example flowchart for facilitating online games with a stateful serverless networking architecture, according to some examples of the present disclosure in accordance with one embodiment.

FIG. 5 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for a low latency stateful serverless networking protocol to support persistent multiplayer state synchronization. For the clients to agree on synchronous state changes without a dedicated server, all clients have to find a way to agree on a final truth state asynchronously to create a same final output. As such, the protocol for serverless networking to support persistent multiplayer state synchronization requires multiple hops for state transmission. The fundamental system is a key-value data store that uses transactions to ensure state coherency synchronized across many clients. Each client subscribes to state updates as well as orchestrates state writes by attempting to lock and write the next available key and then assumes that its state update will succeed to reduce perceived latency. If the key was incorrectly assumed to be submitted in the right order, the client rolls back its assumption and tries the process again.

As described herein, one aspect of the present technology is to provide the protocol for games wherein a certain inherent latency is acceptable. The appropriate games are typically non-twitch-based games with slower action requirements. As such, there is a lesser likelihood of conflict in assumptions of the next available key between the clients. And when there is such a conflict, there may be a snap correction from the client's perspective to a corrected state. Each client therefore retains a best reflection of the shared state and for games such as tabletop games and/or turn-based games, the changes of conflict are greatly reduced, making the effectiveness of this protocol to be a net positive.

Although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

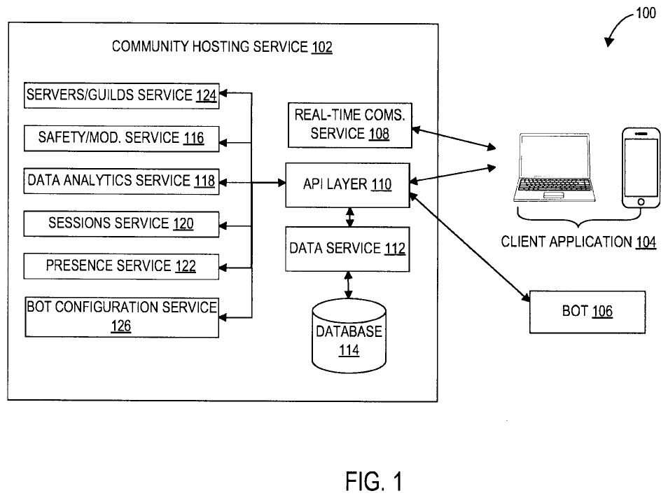

FIG. 1 illustrates an example system 100 configured to support user accounts in creating, managing and participating in online communities. In particular, the system 100 supports a plurality of user accounts interacting with each other in communities to which they belong.

The system 100 illustrates an example architecture in which users of user accounts interact through an instance of client application 104 operating on a computing device. The client application 104 can be provided by a webpage rendered in a web browser or a downloaded client application executed by an operating system of the computing device. In some embodiments, some disparate collections of features or functionality might be available in client application 104 depending on the capabilities of the environment executing or rendering the client application 104.

The system 100 also includes a community hosting service 102, which provides an infrastructure for supporting the plurality of user accounts interacting with each other in communities to which they belong. The community hosting service 102 can be a distributed service hosted in a cloud computing architecture. The community hosting service 102 is responsible for hosting various services accessible to the user accounts by the client application 104.

In some embodiments, the community hosting service 102 provides a servers/guilds service 124 to enable user accounts to set up a server (also referred to as a guild) to host members interacting around one or more channels. A server (or guild) is a user-created environment supporting a community. A server is generally configured with one or more channels which are generally created around topics or sub-topics, or groups of people, and can support exchanges of communications between user accounts. Some channels are non-real-time channels where users communicate through written messages, images, emojis, recorded voice or video files, attachments, etc. Some channels are real-time communications channels that support voice or video communications. Some channels may be able to support both non-real-time messaging and real-time communications.

A user account can operate their instance of the client application 104 to create a server at the community hosting service 102. In some embodiments, this will be performed by the client application 104 calling the API layer 110 requesting to create a new server. The API layer 110 can then interact with servers/guilds service 124 to create the server by providing the server with a unique identifier and associating various configurations requested by the user account. Once the server is created, the user account that created the server can be considered the owner and/or admin for the server. The servers/guilds service 124 can record the information about the server using data service 112 to store information about the server in database 114.

In some embodiments, servers can be configured to be public or private. A public server is one that any user can search for and request to join. A private server is one that a user needs to be invited to join. Depending on the configuration of the private server, a user can be invited by another user or may need to be invited by the administrator of the private server. Users can request to join a public or private server, and an entity with administrative privileges can grant the request.

In some embodiments, servers can be managed by the user account that created the server. Additionally, server administrators can delegate privileges to other user accounts to be administrators, and administrators can also create or invite bots 106, such as a chatbot, to perform some administrative actions.

In addition to approving user accounts to join a server, administrators can also set up various safety or content moderation policies. In some embodiments, those policies are enforced by user accounts with the administrator role for the server. In some embodiments, the policies can be enforced by software services provided by the community hosting service 102, such as the Safety/moderation service 116 or bot 106.

As introduced above, servers are environments for supporting a community and are generally created around topics. In furtherance of that function, servers can be configured to integrate content through embedded channels or webhooks. For example, an administrator of a server might integrate a YOUTUBE channel, a TWITCH feed, or a TWITTER feed into one or more channels of the server when the content of those channels or feeds are relevant to the channel. In some embodiments, a server can follow a channel offered by another server supported by the community hosting service 102.

In addition to hosts, user accounts that are members of a server can also use their instance of client application 104 to interact with the community hosting service 102. The client application 104 can make requests of the community hosting service 102 to initiate a session with the community hosting service 102 and to access servers and channels to which the user account is a member, receive notifications and send messages, and otherwise communicate in the channels in which they belong.

As illustrated in FIG. 1, community hosting service 102 provides a variety of services that can be called by client application 104 or other services of the community hosting service 102.

For example, the community hosting service 102 includes a servers/guilds service 124. The servers/guilds service 124, as described above, can be used to create and administer a server. Additionally, the servers/guilds service 124 can also support various functions to those user accounts that are members of a server. For example, when an instance of client application 104 establishes a session using sessions service 120, the sessions service 120 can interact with servers/guilds service 124 to provide information regarding the servers to which the user account belongs. The client application 104 can receive identifiers of all servers to which the user account operating the client device associated with client application 104 is a member. While the session is active, client application 104 can request updates regarding one or more of the servers to which the user account operating client application 104 belongs from servers/guilds service 124.

Community hosting service 102 also provides a safety/moderation service 116. As with any online community, community hosting service 102 occasionally needs to deal with user accounts issuing spam or inappropriate content. While administrators of servers can perform some moderation functions such as suspending user accounts on a particular server or banning user accounts or bots for inappropriate posts or for posting spam, community hosting service 102 can have various software services that attempt to moderate some posts. For example, safety/moderation service 116 can include algorithms designed to detect hate speech or other harmful or inappropriate content. Safety/moderation service 116 can also include algorithms configured to identify communications as spam or phishing. Safety/moderation service 116 can provide various functions to protect users from content posted in a channel and attacks on client application 104 or the computing device hosting client application 104.

Community hosting service 102 can also include a data analytics service 118. The data analytics service 118 can provide various services in support of community hosting service 102 and in support of the users of community hosting service 102. For example, data analytics service 118 can monitor the performance of various features of the community hosting service 102 to determine whether updates to features are well received by the user community. The data analytics service 118 can also be used to develop and run various machine learning algorithms and other algorithms designed to identify harmful content, malicious servers, malicious user accounts, and malicious bots 106.

As introduced above, sessions service 120 is configured to authenticate a user account to community hosting service 102. After a user account has been authenticated, the sessions service 120 can determine one or more servers to which the user account is a member or for which the user account is an administrator. The sessions service 120 can send a list of identifiers for the servers associated with the user account to the client application 104. Thereafter, the client application 104 can request information regarding the servers by using a session token that validates that the client application 104 is operating in an authenticated session.

The presence service 122 can be used to provide presence information regarding other members of a server or a channel to which the user account belongs. Through the presence service 122, the client application can convey information about which user accounts are currently active in the server or channel. Likewise, the client application 104 can provide presence information for the user account controlling the instance of client application 104.

Community hosting service 102 can also include a real-time communications service 108. The real-time communications service 108 is configured to support real-time communications such as live voice communications or video conferencing. In some embodiments, the real-time communications service 108 can be a public Internet service located outside a gateway for community hosting service 102. Real-time communications service 108 can provide real-time communications for channels configured to support real-time communications.

FIG. 1 also illustrates a bot 106. The bot 106 can be created and configured by users of the community hosting service 102 and linked to servers chosen by the administrator. In some embodiments, the bot 106 can be configured as a chatbot that can have some understanding of the human language through natural language processing technologies. The bot 106 can be configured to provide some content moderation functions and/or some administrative functions. For example, the bot 106 might be granted permission to invite new members, send messages in a channel, embed links, remove members, delete messages, mute members, and attach files, among other possible functions. In some embodiments, bots 106 can have their own user account and are authenticated using a token. Bots 106 can have full access to all services of community hosting service 102. Bots 106 can also be configured as game bots that allow members to play in-server games with one another.

While the community hosting service 102 is shown with just one of each service and database, it will be appreciated by those of ordinary skill in the art that community hosting service 102 can include many instances of each service or database, and in some embodiments, there can be different versions of the service or database that may utilize different technologies such as coding languages, database schemes, etc.

In some embodiments, the community hosting service 102 is configured such that the majority of communications between the community hosting service 102 and the client application 104 pass through API layer 110. The client application 104 can request responses from various services provided by the community hosting service 102 from the API layer 110. Additionally, services within the community hosting service 102 can communicate with each other by sending messages through the API layer 110. The client application 104 can also interact with a real-time communications service 108 for voice and video communication services. Although the community hosting service 102 is be described with respect to a particular system architecture and communication flow, it will be appreciated by those of ordinary skill in the art that other system configurations are possible.

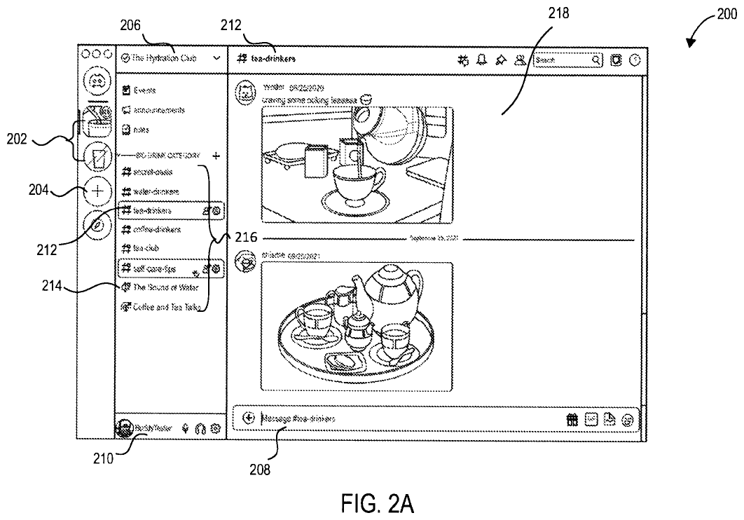

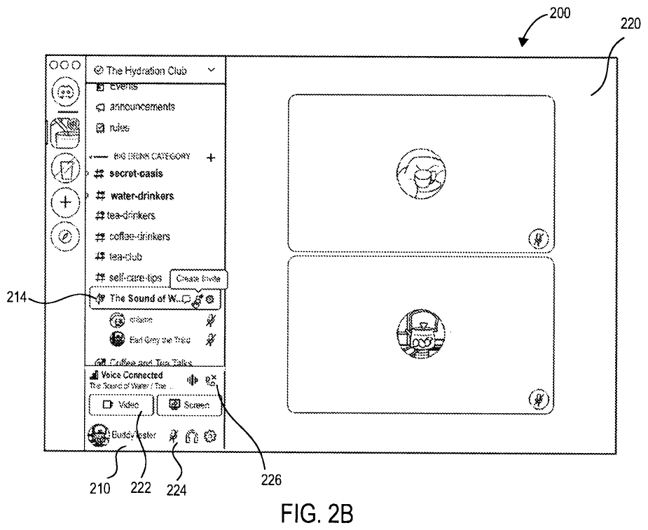

FIG. 2A illustrates an example of user interface 200 presented by client application 104.

User interface 200 includes icons for servers 202. The top icon has been selected and represents the “hydration club” server. The title 206 of the selected server, the “hydration club,” is presented at the top of the user interface 200. User interface 200 also includes a plurality of channels 218 that are part of the server hydration club server. One of the channels, entitled “tea drinkers” 212 is a non-real-time messaging channel. The message thread within the “tea drinkers” 214 channel can be shown within messaging pane 220. As illustrated in FIG. 2A, the messaging pane 218 is configured to present content such as text messages, images, emojis, recorded voice or video files, attachments, etc. A user can provide content to be included in the channel using input interface 208.

User interface 200 also includes a selectable option 204 to add additional servers. User interface 200 also includes a user account icon and controls 210.

FIG. 2B illustrates an example of user interface 200 presented by client application 104. In FIG. 2B channel 214 for the channel entitled “sound of water” has been selected. The “sound of water” channel is a real-time communications channel. Accordingly, messaging pane 220 shows two user accounts engaged in real-time communications. As illustrated in FIG. 2B, the user account icon and controls 210 show that the user accounts microphone 224 is muted. Additionally, the user account has options 222 to share their video or screen. The user account can also disconnect from the real-time communications using option 226.

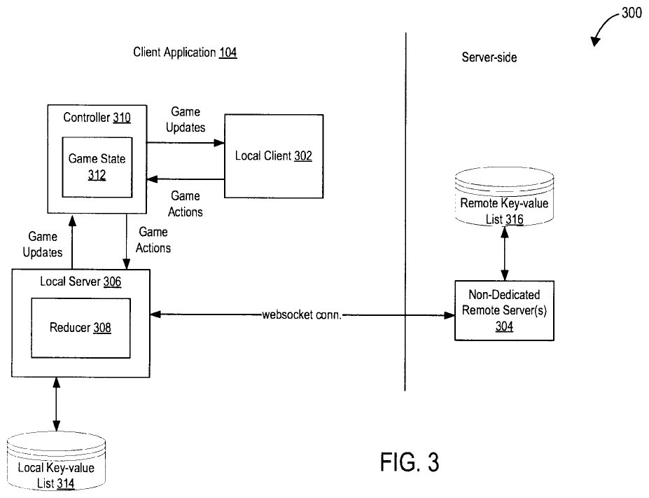

FIG. 3 illustrates an example flow diagram 300 for a low latency stateful serverless networking architecture for facilitating online games, according to some examples of the present disclosure. FIG. 3 only illustrates one local client 302 and one non-dedicated remote server 304 but there may be a plurality of each, wherein a plurality of local clients 302 may be in association with one or more non-dedicated remote servers 304. Non-dedicated remote servers, associated with a “serverless” architecture, are cloud-based servers that are executed and allocated on demand.

The local client 302 may push game state updates associated with requests for game actions in an online game to a local server 306. The local server 306 may execute a reducer 308 that defines the actions that operate on the game state, as well as some hooks for initialization and user presence synchronization. The local client 302 may receive a stream of game state updates from the local server 306 and also sends a stream of game actions to the local server 306.

The local server 306 may maintain a websocket connection with a non-dedicated remote server 304, the websocket connection providing a persistent two-way communication. The local server 306 may fulfill the needs of the local client 302 by pushing state updates and forwarding state actions. Each game activity instance may be assigned a dedicated database path to manage shared data including its game state. The game state may be stored locally as a local ordered key-value list 314 that the local server 306 both listens for new keys, such as other client updates that need to be propagated locally, as well as pushing new keys, such as local updates that need to be propagated to other clients.

A controller 310 may run both the local client 302 and the local server 306 and may implement the protocol as well. The controller 310 manages the interoperation between the two as if it were a traditional server-client architecture. In addition, the controller 310 may expose a game state 312 via a game state object and application programming interface (API) that enables a game activity to read and write the shared state. With respect to the protocol, state updates are stored as a list of ordered keys and each payload is a set of path, and each path will correspond to an entry in a local key-value list 308. The local key-value list 314 is a versioned data model that organizes data that is synchronized to a remote key-value list 316. The local key-value list 314 is a collection of data primitives that the protocol provides to describe the data model. Specifically, the local key-value list 314 includes, for example, a value, which may be plain data: string, number, Boolean, or objects, a list that may be an array of data, a map that may be a key-value record of data, an action that may be requested to be executed on the current state, and a callback that may be scheduled actions.

A game state 312 may be exposed to the game activity to allow it to receive state updates from the local server 306, as well as send actions to it. The game state 312 subscribes to the local client updates from other clients to reflect server changes to its local state, as well as pushes its local changes to the remote server 304 via the local client actions.

As such, when the local server 306 subscribes to updates from the remote server 304, local server 306 receives an initial key-value list and locally reconstructs the game state and records a last known key. As game state updates are received, they are sequentially applied to the local game state and the last known key is updated. In addition, a state update payload may be the result of one or more actions, that is, there is no strict one to one relationship of actions to game state updates. For instance, to avoid any one game state list from growing unbounded, the game state is regularly collapsed to control storage limits.

In a traditional server-client architecture there is only a single round trip: the client sends a request to the server, and the server sends a confirmation to the client. However, in a serverless protocol, the synchronization of game state updates requires minimally double the trips to coordinate between many clients. Therefore, by allowing a client to prematurely assume that its update will succeed after only a single round trip, each client is not beholden to the confirmation to continue with the game.

Each local client 302 contends for the next known available key known to them, and if available, the local client 302 issues the server state update as well as immediately applying it to its local state, without waiting for the confirmation. If the key is not available, it means another client beat it to reserve the next available key, so the client retires the state update and rolls back its local state. The controller 310 will then retry the process to apply the action.

The game state update is wholly re-started because the action attempt must be run against the updated server state that the local client had not yet received at the time it initially attempted the action. Action retries are costly and can in theory drown out clients under the perfect storm of unfortunate conditions, but for non-twitch-games, action retries are highly unlikely. For example, non-twitch-games may include activities with concurrent action such as sharing drawing, trivia, etc. Each client is action-rate-limited to both prohibit any one client from dominating as well as to reduce potential pressure on the system.

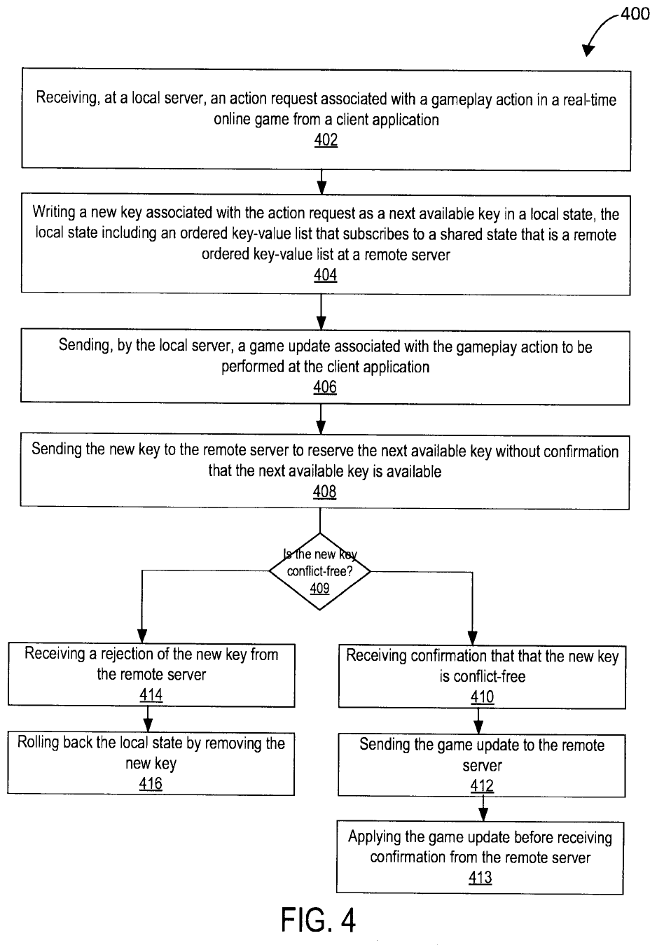

FIG. 4 illustrates an example method 400 for facilitating online games with a stateful serverless networking architecture, according to some examples of the present disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes receiving, at an initial state, an action request associated with a gameplay action in a real-time online game from a client application at block 402. For example, a local server 306, an example of which is illustrated in FIG. 3, may receive the action request and the real-time online game may be a non-twitch-based game. As an example, the gameplay action may be to pick up a ball in a game environment of the real-time online game. In some cases, the local server may be associated with a community hosting service and may maintain a websocket connection with the remote server of a third-party hosting service, wherein the remote server is a non-dedicated server.

According to some examples, the method 400 includes writing a new key associated with the action request as a next available key in a local state, at block 404. The local state may include an ordered key-value list that subscribes to a shared state that is a remote ordered key-value list at a remote server. Furthermore, the local server may execute a local reducer that subscribes to the shared state and the local reducer sends the new key. For example, a local server 306, an example of which is illustrated in FIG. 3, may write the new key, and continuing the example above, the key may be associated with picking up the ball.

According to some examples, the method 400 includes sending a game update associated with the gameplay action to be performed at the client application at block 406. For example, a local server 306, an example of which is illustrated in FIG. 3, may send the game update. Continuing the example above, the game update for picking up the ball may be sent back to the client application to be accepted and displayed in the gaming environment. Whether or not the action of picking up the ball is an available next move is ignored at this step to reduce perceived latency.

According to some examples, the method 400 includes sending the new key to the remote server to reserve the next available key without confirmation that the next available key is available at block 408. For example, a local server 306, an example of which is illustrated in FIG. 3, may send the new key to the remote server. In some cases, a transaction primitive is used to provide contentious write access to the same location on the remote server. The operation optimizes for the validation of existing data, and this optimization is exploited by taking the absence of data as sufficient confirmation that the client has acquired the key.

According to some examples, the method 400 includes that the remote server determines whether the new key is conflict free. In some cases, the local server may receive confirmation that the new key is conflict-free at block 410 and in response, send the game update to the remote server to be synchronized with other client devices in block 412, and applying the game update before receiving confirmation from the remote server in block 413. This should be the most often result, especially for non-twitch games and/or turn-based table-top games such as chess.

In other cases, when another user has already reserved the next available key, the method includes receiving a rejection of the new key from the remote server in block 414. As such, the local state may be rolled back by removing the new key in block 416. To continue the example above, another player may have already picked up the ball and therefore the game is rolled back to the initial state when the ball was not picked up. Then, the local state subscribing to the shared state is updated to include a key that reflects that another player has picked up the ball, which may then be shared as a game update to the client application. From the player's perspective, it may appear for a moment that the player picked up the ball but then a snap correction may occur that puts the ball back down and then may further progress to show that the other player has actually picked up the ball. In turn-based table-top games such as chess, such conflicts are highly unlikely and therefore using this serverless protocol should not result in many rollbacks.

In some cases, a controller runs both the local server and the client application and manages an interoperation between the local server and the client application. In addition, the controller may provide a protocol that provides the ordered key-value list. In some cases, the controller may expose a game state object that enables game activities to read and write the shared state.

In some case, a second remote ordered key-value list that is run concurrent to the remote order key-value list may be subscribed to and a second new key may be sent to the second remote ordered key-value list with a key value and without a payload. Once the confirmation that the key value is accepted, the payload is then sent. In some cases, the bandwidth can be cut in half.

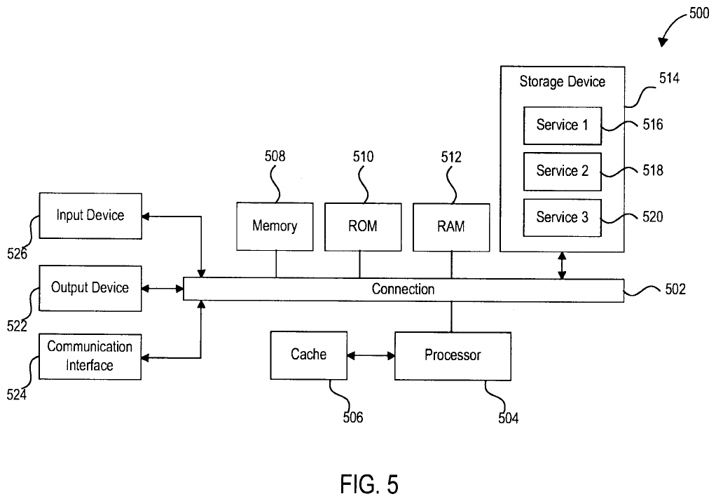

FIG. 5 shows an example of computing system 500, which can be for example any computing device making up client application 104, community hosting service 102, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 506 connected directly with, in close proximity to, or integrated as part of processor 504.

Processor 504 can include any general purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Illustrative examples of the disclosure include:

Aspect 1. A computer-implemented method, comprising: receiving, at an initial state by a local server, an action request associated with a gameplay action in a real-time online game from a client application; writing a new key associated with the action request as a next available key in a local state, the local state including an ordered key-value list that subscribes to a shared state that is a remote ordered key-value list at a remote server; sending, by the local server, a game update associated with the gameplay action to be performed at the client application; and
sending the new key to the remote server to reserve the next available key without confirmation that the next available key is available.

Aspect 2. The computer-implemented method of Aspect 1, further comprising: receiving a rejection of the new key from the remote server; rolling back the local state by removing the new key; and sending a roll-back game update to the client application to roll back to the initial state.

Aspect 3. The computer-implemented method of any Aspects 1 to 2, further comprising: receiving confirmation that that the new key is conflict-free; and sending the game update to the remote server.

Aspect 4. The computer-implemented method of any Aspects 1 to 3, wherein a controller that runs both the local server and the client application manages an interoperation between the local server and the client application, wherein the controller provides a protocol that provides the ordered key-value list.

Aspect 5. The computer-implemented method of any Aspects 1 to 4, wherein the controller exposes a game state object that enables game activities to read and write the shared state.

Aspect 6. The computer-implemented method of any Aspects 1 to 5, wherein the local server is associated with a community hosting service and maintains a websocket connection with the remote server of a third-party hosting service, wherein the remote server is a non-dedicated server.

Aspect 7. The computer-implemented method of any Aspects 1 to 6, further comprising: executing, by the local server, a local reducer that subscribes to the shared state, wherein the local reducer sends the new key.

Aspect 8. The computer-implemented method of any Aspects 1 to 7, further comprising: subscribing to a second remote ordered key-value list that is run concurrent to the remote ordered key-value list; sending a second new key to the second remote ordered key-value list with a key value and without a payload; receiving confirmation that the key value is accepted; and sending the payload.

Aspect 9. A non-transitory computer-readable medium comprising instructions, the instructions, when executed by a computing system, causes the computing system to: receive, at an initial state by a local server, an action request associated with a gameplay action in a real-time online game from a client application; write a new key associated with the action request as a next available key in a local state, the local state including an ordered key-value list that subscribes to a shared state that is a remote ordered key-value list at a remote server; send, by the local server, a game update associated with the gameplay action to be performed at the client application; and send the new key to the remote server to reserve the next available key without confirmation that the next available key is available.

Aspect 10. The non-transitory computer-readable medium of Aspect 9, wherein the instructions, when executed by the computing system, causes the computing system to: receive a rejection of the new key from the remote server; roll back the local state by removing the new key; and send a roll-back game update to the client application to roll back to the initial state.

Aspect 11. The non-transitory computer-readable medium of any Aspects 9 to 10 wherein the instructions, when executed by the computing system, causes the computing system to: receiving confirmation that that the new key is conflict-free; and sending the game update to the remote server.

Aspect 12. The non-transitory computer-readable medium of any Aspects 9 to 11, wherein a controller that runs both the local server and the client application manages an interoperation between the local server and the client application, wherein the controller provides a protocol that provides the ordered key-value list.

Aspect 13. The non-transitory computer-readable medium of any Aspects 9 to 12, wherein the controller exposes a game state object that enables game activities to read and write the shared state.

Aspect 14. The non-transitory computer-readable medium of any Aspects 9 to 13, wherein the local server is associated with a community hosting service and maintains a websocket connection with the remote server of a third-party hosting service, wherein the remote server is a non-dedicated server.

Aspect 15. The non-transitory computer-readable medium of any Aspects 9 to 14, wherein the instructions, when executed by the computing system, causes the computing system to: execute, by the local server, a local reducer that subscribes to the shared state, wherein the local reducer sends the new key.

Aspect 16. The non-transitory computer-readable medium of any Aspects 9 to 15, wherein the instructions, when executed by the computing system, causes the computing system to: subscribing to a second remote ordered key-value list that is run concurrent to the remote ordered key-value list; sending a second new key to the second remote ordered key-value list with a key value and without a payload; receiving confirmation that the key value is accepted; and sending the payload.

Aspect 17. A system comprising: one or more processors; and a non-transitory computer-readable medium comprising instructions, the instructions, when executed by the one or more processors, causes the one or more processors to: receive, at an initial state by a local server, an action request associated with a gameplay action in a real-time online game from a client application; write a new key associated with the action request as a next available key in a local state, the local state including an ordered key-value list that subscribes to a shared state that is a remote ordered key-value list at a remote server; send, by the local server, a game update associated with the gameplay action to be performed at the client application; and send the new key to the remote server to reserve the next available key without confirmation that the next available key is available.

Aspect 18. The system of Aspect 17 wherein the instructions, when executed by the one or more processors, causes the one or more processors to: receive a rejection of the new key from the remote server; roll back the local state by removing the new key; and send a roll-back game update to the client application to roll back to the initial state.

Aspect 19. The system of any of Aspect 17 to 18 wherein the instructions, when executed by the one or more processors, causes the one or more processors to: receive confirmation that that the new key is conflict-free; and send the game update to the remote server.

Aspect 20. The system of any of Aspect 17 to 19, wherein a controller that runs both the local server and the client application manages an interoperation between the local server and the client application, wherein the controller provides a protocol that provides the ordered key-value list.

What is claimed is:

1. A computer-implemented method, comprising:
receiving, at an initial state by a local server, an action request associated with a gameplay action in a real-time online game from a client application;
writing a new key associated with the action request as a next available key in a local state, the local state including an ordered key-value list that subscribes to a shared state that is a remote ordered key-value list at a remote server;
sending, by the local server, a game update associated with the gameplay action to be performed at the client application; and
sending the new key to the remote server to reserve the next available key without confirmation that the next available key is available.

2. The computer-implemented method of claim 1, further comprising:
receiving a rejection of the new key from the remote server;
rolling back the local state by removing the new key; and
sending a roll-back game update to the client application to roll back to the initial state.

3. The computer-implemented method of claim 1, further comprising:
receiving confirmation that that the new key is conflict-free; and
sending the game update to the remote server.

4. The computer-implemented method of claim 1, wherein a controller that runs both the local server and the client application manages an interoperation between the local server and the client application, wherein the controller provides a protocol that provides the ordered key-value list.

5. The computer-implemented method of claim 4, wherein the controller exposes a game state object that enables game activities to read and write the shared state.

6. The computer-implemented method of claim 1, wherein the local server is associated with a community hosting service and maintains a websocket connection with the remote server of a third-party hosting service, wherein the remote server is a non-dedicated server.

7. The computer-implemented method of claim 1, further comprising:
executing, by the local server, a local reducer that subscribes to the shared state, wherein the local reducer sends the new key.

8. The computer-implemented method of claim 1, further comprising:
subscribing to a second remote ordered key-value list that is run concurrent to the remote ordered key-value list;
sending a second new key to the second remote ordered key-value list with a key value and without a payload;
receiving confirmation that the key value is accepted; and
sending the payload.

9. A non-transitory computer-readable medium comprising instructions, the instructions, when executed by a computing system, causes the computing system to:
receive, at an initial state by a local server, an action request associated with a gameplay action in a real-time online game from a client application;
write a new key associated with the action request as a next available key in a local state, the local state including an ordered key-value list that subscribes to a shared state that is a remote ordered key-value list at a remote server;
send, by the local server, a game update associated with the gameplay action to be performed at the client application; and
send the new key to the remote server to reserve the next available key without confirmation that the next available key is available.

10. The non-transitory computer-readable medium of claim 9, wherein the instructions, when executed by the computing system, causes the computing system to:
receive a rejection of the new key from the remote server;
roll back the local state by removing the new key; and
send a roll-back game update to the client application to roll back to the initial state.

11. The non-transitory computer-readable medium of claim 9, wherein the instructions, when executed by the computing system, causes the computing system to:
receiving confirmation that that the new key is conflict-free; and
sending the game update to the remote server.

12. The non-transitory computer-readable medium of claim 9, wherein a controller that runs both the local server and the client application manages an interoperation between the local server and the client application, wherein the controller provides a protocol that provides the ordered key-value list.

13. The non-transitory computer-readable medium of claim 12, wherein the controller exposes a game state object that enables game activities to read and write the shared state.

14. The non-transitory computer-readable medium of claim 9, wherein the local server is associated with a community hosting service and maintains a websocket connection with the remote server of a third-party hosting service, wherein the remote server is a non-dedicated server.

15. The non-transitory computer-readable medium of claim 9, wherein the instructions, when executed by the computing system, causes the computing system to:
execute, by the local server, a local reducer that subscribes to the shared state, wherein the local reducer sends the new key.

16. The non-transitory computer-readable medium of claim 9, wherein the instructions, when executed by the computing system, causes the computing system to:
subscribing to a second remote ordered key-value list that is run concurrent to the remote ordered key-value list;
sending a second new key to the second remote ordered key-value list with a key value and without a payload;
receiving confirmation that the key value is accepted; and
sending the payload.

17. A system comprising:
one or more processors; and
a non-transitory computer-readable medium comprising instructions, the instructions, when executed by the one or more processors, causes the one or more processors to:
receive, at an initial state by a local server, an action request associated with a gameplay action in a real-time online game from a client application;
write a new key associated with the action request as a next available key in a local state, the local state including an ordered key-value list that subscribes to a shared state that is a remote ordered key-value list at a remote server;
send, by the local server, a game update associated with the gameplay action to be performed at the client application; and
send the new key to the remote server to reserve the next available key without confirmation that the next available key is available.

18. The system of claim 17 wherein the instructions, when executed by the one or more processors, causes the one or more processors to:
receive a rejection of the new key from the remote server;
roll back the local state by removing the new key; and
send a roll-back game update to the client application to roll back to the initial state.

19. The system of claim 17 wherein the instructions, when executed by the one or more processors, causes the one or more processors to:
receive confirmation that that the new key is conflict-free; and
send the game update to the remote server.

20. The system of claim 17, wherein a controller that runs both the local server and the client application manages an interoperation between the local server and the client application, wherein the controller provides a protocol that provides the ordered key-value list.
